(19) United States
(12) Patent Application Publication
(10) Pub. No.: US 2026/0296756 A1
(43) Pub. Date: Oct. 1, 2026

(54) ANTI-CORROSION POLYMERIC PACKAGING SYSTEM

(71) Applicant: PacTec, Inc., Clinton, LA (US)

(72) Inventors: Michael R. Schilling, Clinton, LA (US); Troy Town, Clinton, LA (US)

(21) Appl. No.: 19/578,460

(22) Filed: Mar. 25, 2026

Related U.S. Application Data
(60) Provisional application No. 63/777,392, filed on Mar. 25, 2025.

(51) Int. Cl. B65D 77/02; B65B 5/04; B65B 7/02; B65D 77/12; B65D 77/26; B65D 81/24

(52) U.S. Cl. CPC B65D 77/02; B65B 5/045; B65B 7/02; B65D 77/12; B65D 77/26; B65D 81/245

(57) ABSTRACT

An anti-corrosion packaging system includes a soft-sided outer container formed from a polymeric fabric and defining an interior volume sized to receive an industrial item. The outer container optionally includes a hermetic zipper closure. A floor mat is positioned at a bottom of the interior volume to support the industrial item and provide puncture resistance and moisture isolation. An anti-corrosion film incorporating vapor corrosion inhibitors is positioned around the industrial item to emit corrosion-inhibiting vapors into an environment surrounding the item, and one or more additional corrosion inhibitor sources may be disposed within the interior volume. In some embodiments, the anti-corrosion film surrounds both the industrial item and the floor mat and includes an open end that is sealed using a tubular compression closure assembly to form a substantially sealed anti-corrosion envelope.

### CROSS-REFERENCE TO RELATED APPLICATIONS

This application claims priority to U.S. Provisional Application No. 63/777,392, filed on Mar. 25, 2025, which is hereby incorporated by reference in its entirety.

### BACKGROUND

Large industrial components and equipment are frequently shipped and stored for extended periods prior to installation or use. During shipping and storage, such items may be exposed to environmental conditions—including humidity, condensation, temperature fluctuations, and airborne contaminants—that can lead to corrosion, oxidation, or other forms of material degradation. Preventing corrosion during these periods is particularly relevant for metal components, precision equipment, and other industrial assets where surface integrity and performance tolerances are of concern.

Corrosion protection for large industrial items has conventionally been achieved through the use of rigid metal shipping containers. These containers are commonly outfitted with moisture-control features, exterior protective coatings, vapor corrosion inhibitors, and desiccants intended to reduce humidity and inhibit corrosive processes within the container interior. When properly maintained and sealed, such metal containers can provide a controlled environment suitable for long-term storage or transport.

However, the use of metal shipping containers presents a number of drawbacks. The containers themselves are susceptible to damage and degradation over time, including dents, seam separation, corrosion of the container material itself, and roof or panel damage. Such defects may compromise the container's ability to prevent water intrusion, thereby undermining the effectiveness of internal corrosion-control measures. As a result, metal containers typically require regular inspection, maintenance, and repair to ensure continued performance. These activities increase operational costs, introduce logistical complexity, and may require specialized labor or facilities.

Additionally, the weight, rigidity, and fixed geometry of metal shipping containers can limit flexibility in packaging and handling large or irregularly shaped industrial items. Transporting, storing, and maintaining empty containers can also present challenges, particularly in applications where containers are reused or repositioned across multiple sites. The storage footprint of empty rigid containers may be substantial, and the containers may not readily adapt to items of varying sizes or configurations.

Accordingly, there remains interest in packaging solutions for industrial shipping and storage applications that provide effective corrosion protection while reducing or eliminating the maintenance, inspection, and logistical burdens associated with conventional metal shipping containers.

### SUMMARY

The present disclosure provides an anti-corrosion packaging system that enables effective corrosion protection for large industrial items while reducing the maintenance, rigidity, and logistical burdens associated with conventional metal shipping containers. The anti-corrosion packaging system includes a soft-sided outer container formed from a polymeric fabric and defining an interior volume sized to receive an industrial item. In certain embodiments, the outer container includes a liquid-tight and gas-tight closure (e.g., a hermetic zipper closure) positioned along an upper portion of the outer container. In other embodiments, any suitable closure—such as a traditional zipper closure or a hook-and-loop fastener—may be utilized as a closure means for the outer container. The anti-corrosion packaging system further includes a floor mat positioned at a bottom of the interior volume. The floor mat is configured to support the industrial item and provide puncture resistance and moisture isolation. The anti-corrosion packaging system further includes an anti-corrosion film configured to be positioned around the industrial item. The anti-corrosion film comprises a polymeric material incorporating vapor corrosion inhibitors configured to emit corrosion-inhibiting vapors into an enclosed environment surrounding the industrial item. The anti-corrosion packaging system further includes one or more anti-corrosion inhibitor sources disposed within the interior volume.

According to other aspects of the present disclosure, the anti-corrosion packaging system may include one or more of the following features. The outer container may feature a liquid-tight and gas-tight closure comprising a hermetic zipper extending along the upper portion of the outer container. The outer container may comprise heat-sealed seams. The polymeric fabric may comprise vinyl. The floor mat may comprise a rubber mat or an elastomeric mat. The anti-corrosion packaging system may further include a protective insert configured to be positioned between the industrial item and the outer container to protect the outer container from sharp edges or protrusions on the industrial item. The protective insert may comprise a non-woven polypropylene sheet. The anti-corrosion film may be positioned over the industrial item with an open end of the anti-corrosion film tucked beneath the floor mat. The one or more anti-corrosion inhibitor sources may comprise vapor corrosion inhibitor emitters, vapor corrosion inhibitor capsules, or vapor corrosion inhibitor blocks. The anti-corrosion packaging system may further include one or more cinch straps with D-rings positioned on an exterior of the outer container.

According to another aspect of the present disclosure, an anti-corrosion packaging system is provided. The anti-corrosion packaging system includes a soft-sided outer container formed from a polymeric fabric and defining an interior volume sized to receive an industrial item. The outer container may include a closure positioned along an upper portion of the outer container. The anti-corrosion packaging system further includes a floor mat positioned at a bottom of the interior volume. The anti-corrosion packaging system further includes an anti-corrosion film configured to be positioned around both the industrial item and the floor mat, the anti-corrosion film comprising a polymeric material incorporating vapor corrosion inhibitors. The anti-corrosion film defines an open upper end extending upward and accessible from above. The anti-corrosion packaging system further includes a tubular compression closure system configured to seal the open upper end of the anti-corrosion film, the tubular compression closure system providing a liquid-tight and gas-tight seal for the enclosed environment. The anti-corrosion packaging system further includes one or more anti-corrosion inhibitor sources disposed within the anti-corrosion film.

According to other aspects of the present disclosure, the anti-corrosion packaging system may include one or more of the following features. The tubular compression closure system may comprise an inner rod having a circular cross-section, a slotted resilient sleeve clamp having a circular cross-section and adapted to mate to the inner rod and apply a compressive force, and first and second end caps configured to secure the sleeve clamp to the inner rod. The sleeve clamp may be constructed of a resilient material comprising an elastomeric plastic. The sleeve clamp may have an inner diameter approximately the same as an outer diameter of the inner rod. A longitudinal slot may be formed in the sleeve clamp to facilitate the sleeve clamp being slid over the inner rod. The open upper end of the anti-corrosion film may be wrapped around the inner rod, and the sleeve clamp may be applied to compress the anti-corrosion film against the inner rod to form a substantially sealed anti-corrosion envelope around the industrial item. The anti-corrosion packaging system may further include a protective insert comprising a non-woven polypropylene sheet configured to be positioned between the industrial item and the outer container. The outer container may comprise heat-sealed seams. The floor mat may comprise a rubber mat or an elastomeric mat.

According to another aspect of the present disclosure, a method of packaging an industrial item for corrosion-protected shipping or storage is provided. The method includes positioning a floor mat at a bottom of an interior volume of a soft-sided outer container formed from a polymeric fabric. The method further includes placing the industrial item on the floor mat within the interior volume. The method further includes positioning an anti-corrosion film around the industrial item. The anti-corrosion film comprises a polymeric material incorporating vapor corrosion inhibitors configured to emit corrosion-inhibiting vapors. The method further includes disposing one or more anti-corrosion inhibitor sources within the interior volume. The method further includes closing the outer container. In certain embodiments, the outer container is closed using a liquid-tight and gas-tight closure positioned along an upper portion of the outer container.

According to other aspects of the present disclosure, the method may include one or more of the following features. Positioning the anti-corrosion film may comprise positioning the anti-corrosion film over the industrial item and tucking an open end of the anti-corrosion film beneath the floor mat. Positioning the anti-corrosion film may comprise positioning the anti-corrosion film around both the industrial item and the floor mat such that an open upper end of the anti-corrosion film extends upward. The method may further include sealing the open upper end of the anti-corrosion film using a tubular compression closure system. The method may further include wrapping sharp edges of the industrial item with a protective insert comprising a non-woven polypropylene sheet prior to positioning the anti-corrosion film.

The above summary is not intended to describe each illustrated embodiment or every possible implementation. These and other features, aspects, and advantages of the present invention will become better understood with regard to the following description, appended claims, and accompanying drawings.

### BRIEF DESCRIPTION OF FIGURES

The accompanying figures, together with the detailed description below, are incorporated in and form part of the specification, serve to illustrate further various exemplary embodiments and to explain various principles and advantages in accordance with the present invention:

FIG. 1 illustrates an isometric view of an anti-corrosion packaging system in a closed configuration, according to aspects of the present disclosure.

FIG. 2 illustrates an isometric view of the anti-corrosion packaging system of FIG. 1 in an open configuration, according to aspects of the present disclosure.

FIG. 3 illustrates a partially exploded view of the anti-corrosion packaging system of FIG. 1 showing internal components, according to aspects of the present disclosure.

FIG. 4 illustrates an exploded view of the anti-corrosion packaging system of FIG. 1, according to aspects of the present disclosure.

FIG. 5 illustrates an isometric view of an anti-corrosion packaging system in a closed configuration, according to a second embodiment of the present disclosure.

FIG. 6 illustrates an exploded isometric view of the anti-corrosion packaging system of FIG. 5, according to aspects of the present disclosure.

FIG. 7 illustrates an isometric view of an anti-corrosion packaging system in a closed configuration, according to a third embodiment of the present disclosure.

FIG. 8 illustrates an exploded view of the anti-corrosion packaging system of FIG. 7, according to aspects of the present disclosure.

FIG. 9A illustrates an isometric view of the anti-corrosion packaging system of FIG. 7 with a tubular compression closure assembly in an open configuration, according to aspects of the present disclosure.

FIG. 9B illustrates an isometric view of the anti-corrosion packaging system of FIG. 7 with the tubular compression closure assembly in a partially assembled state, according to aspects of the present disclosure.

FIG. 9C illustrates an isometric view of the anti-corrosion packaging system of FIG. 7 with the tubular compression closure assembly in a partially assembled configuration, according to aspects of the present disclosure.

FIG. 9D illustrates an isometric view of the anti-corrosion packaging system of FIG. 7 with the tubular compression closure assembly in a closed configuration, according to aspects of the present disclosure.

FIG. 9E illustrates an isometric view of the anti-corrosion packaging system of FIG. 7 with the tubular compression closure assembly in a closed configuration, according to aspects of the present disclosure.

### DETAILED DESCRIPTION

Detailed embodiments of the present invention are disclosed herein. However, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting, but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include, other elements not expressly listed or inherent to such process, method, article, or apparatus. An element proceeded by “comprises” does not, without more constraints, preclude the existence of additional identical elements in the process, method, article, or apparatus that comprises the element. The terms “including,” “having,” or “featuring,” as used herein, are defined as comprising (i.e., open language). The term “coupled,” as used herein, is defined as connected, although not necessarily directly, and not necessarily mechanically. As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions.

The present disclosure relates to soft-sided polymeric packaging systems configured for transporting and storing large industrial items that require protection from corrosion during shipping, staging, or long-term storage. Industrial components, including metal components, precision equipment, and other industrial assets where surface integrity and performance tolerances are relevant, may be exposed to environmental conditions during shipping and storage periods. Such environmental conditions may include humidity, condensation, and temperature fluctuations that can lead to corrosion, oxidation, or other forms of material degradation.

Conventional approaches to corrosion protection for large industrial items have included the use of rigid metal shipping containers. Such metal containers may be outfitted with moisture-control features, exterior protective coatings, vapor corrosion inhibitors, and desiccants intended to reduce humidity and inhibit corrosive processes within the container interior. However, metal shipping containers may be susceptible to damage and degradation over time, including dents, seam separation, corrosion of the container itself, and roof or panel damage. Such defects may compromise the ability of the container to prevent water intrusion, thereby undermining the effectiveness of internal corrosion-control measures. Metal containers may require regular inspection, maintenance, and repair to ensure continued performance, which may increase operational costs, introduce logistical complexity, and require specialized labor or facilities.

The weight, rigidity, and fixed geometry of metal shipping containers may also limit flexibility in packaging and handling large or irregularly shaped industrial items. Transporting, storing, and maintaining empty metal containers may present challenges, particularly in applications where containers are reused or repositioned across multiple sites.

The soft-sided polymeric packaging systems described herein may address one or more of these limitations by providing effective corrosion protection while reducing or eliminating the maintenance, inspection, and logistical burdens associated with conventional metal shipping containers. The soft-sided, modular nature of the packaging systems described herein may allow for improved handling flexibility, reduced storage footprint when empty, and adaptability to a range of industrial shipping and storage applications. The packaging systems may incorporate anti-corrosion films, anti-corrosion inhibitor sources, protective inserts, and floor mats within a soft-sided outer container to create a corrosion-inhibiting environment for industrial items without requiring the use of rigid metal enclosures.

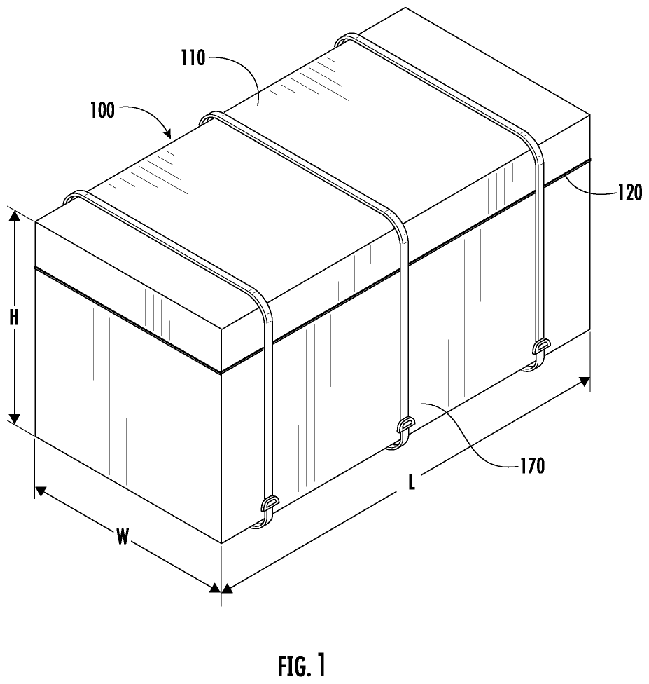

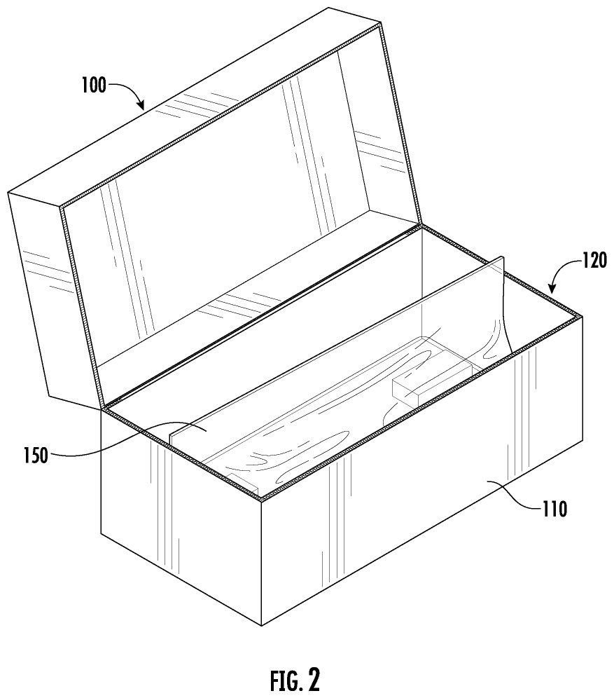

Referring to FIGS. 1 and 2, an anti-corrosion packaging system 100 according to a first embodiment is illustrated. The anti-corrosion packaging system 100 includes an outer shell 110 formed from a polymeric fabric material. In some cases, the outer shell 110 may be formed from an 18 oz vinyl polymeric fabric material. The outer shell 110 defines an interior volume sized to receive an industrial item. The outer shell 110 exhibits a soft-sided construction that allows the anti-corrosion packaging system 100 to accommodate industrial items while providing a flexible and collapsible form factor when not in use.

As shown in FIG. 1, the outer shell 110 has a generally rectangular configuration with dimensions defined by a height H, a width W, and a length L. The dimensions H, W, and L may be selected based on the size, shape, and configuration of the industrial item to be packaged. It should be understood that the illustrated rectangular configuration is exemplary, and that the outer shell 110 may alternatively have other shapes or geometries, including cylindrical, polygonal, or irregular configurations, depending on the industrial item being packaged.

With continued reference to FIG. 1, a hermetic zipper 120 is positioned along an upper portion of the outer shell 110. The hermetic zipper 120 extends across a top surface of the outer shell 110 to enable selective opening and closing of the interior volume. The hermetic zipper 120 provides a seal that resists the ingress of liquids and gases into the interior of the anti-corrosion packaging system 100. In some cases, the hermetic zipper 120 may extend around portions of the sides of the outer shell 110 to facilitate access to the interior volume.

As further shown in FIG. 1, cinch straps 170 are positioned on an exterior of the outer shell 110. The cinch straps 170 are arranged at multiple locations around a perimeter of the anti-corrosion packaging system 100 to facilitate securing and handling of the packaging system during transport and storage. In some cases, the anti-corrosion packaging system 100 may include three cinch straps 170 per bag for securing the outer shell 110. The cinch straps 170 may be 12-inch cinch straps with 1.5-inch black webbing and double D-rings on one end. The double D-rings allow for adjustable tensioning of the cinch straps 170 around the exterior of the outer shell 110.

Referring to FIG. 2, the anti-corrosion packaging system 100 is shown in an open configuration. The outer shell 110 includes a hinged lid portion that is shown in an open position, revealing the interior volume. The hermetic zipper 120 is visible along the upper portion of the outer shell 110, with the hermetic zipper 120 providing a liquid-tight and gas-tight closure when the outer shell 110 is in a closed configuration. The outer shell 110 may include heat-sealed seams along edges of the outer shell 110 to maintain structural integrity and environmental isolation.

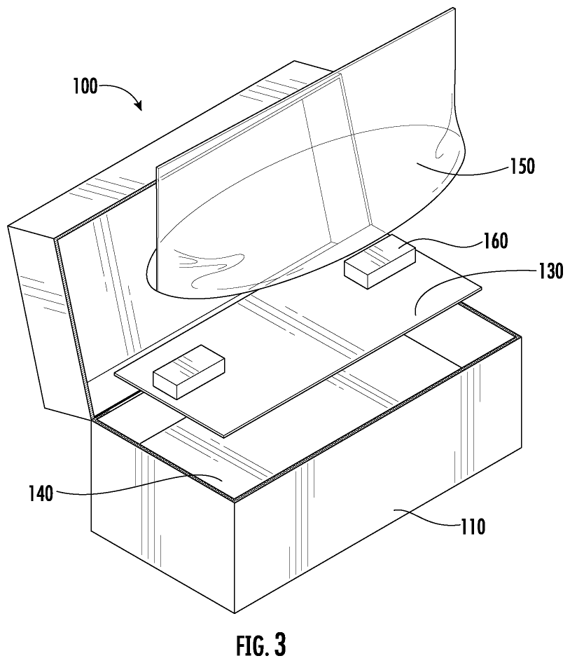

Referring to FIG. 3, the anti-corrosion packaging system 100 is shown in an open configuration with the internal components positioned within the outer shell 110. The outer shell 110 is illustrated with a lid portion opened to reveal the interior volume and the arrangement of the internal packaging components during use.

A rubber matting 140 is positioned along a bottom of the interior volume of the outer shell 110. The rubber matting 140 functions as a bottom lining that supports an industrial item and provides moisture isolation and puncture resistance. In some embodiments, the rubber matting 140 may be shipped separately and placed within the outer shell 110 at the time of use.

With continued reference to FIG. 3, a polymeric insert 130 is positioned within the interior of the outer shell 110, such as above the rubber matting 140 and beneath the industrial item. The polymeric insert 130 is configured to wrap, shield, or otherwise cover sharp edges or protrusions of the industrial item to protect the outer shell 110 and other internal packaging components. In some embodiments, the polymeric insert 130 comprises a non-woven polypropylene material, such as a 12 oz non-woven polypropylene insert, and may be selectively positioned at locations corresponding to sharp edges or high-stress regions of the item.

An anti-corrosion film 150 may be positioned within the interior volume of the anti-corrosion packaging system 100. The anti-corrosion film 150 comprises a polymeric material incorporating vapor corrosion inhibitors (VCIs) configured to emit corrosion-inhibiting vapors into an enclosed environment surrounding an industrial item. In some embodiments, the anti-corrosion film 150 may comprise a polymeric sheet, sleeve, envelope, or bag incorporating vapor corrosion inhibitors, including commercially available VCI protection films or bags, such as those marketed under the ZeRust® brand, although other VCI-containing polymeric films may be used. As depicted in FIG. 3, the anti-corrosion film 150 is draped over the polymeric insert 130 and extends toward the rubber matting 140. The anti-corrosion film 150 may be positioned over the industrial item with an open end tucked beneath the rubber matting 140. In this configuration, the continuous emission of corrosion-inhibiting vapors from the anti-corrosion film 150 maintains a protective environment around the industrial item, even though the anti-corrosion film 150 is not hermetically sealed.

As further shown in FIG. 3, an anti-corrosion block 160 is disposed within the interior volume of the anti-corrosion packaging system 100. The anti-corrosion block 160 functions as an anti-corrosion inhibitor source that emits vapor corrosion inhibitors to maintain a corrosion-inhibiting atmosphere within the anti-corrosion packaging system 100. In some cases, the anti-corrosion block 160 may comprise ZeRust rust prevention vapor capsules that emit corrosion-inhibiting vapors. In some cases, the anti-corrosion block 160 may comprise INTERCEPT Technology copper-based corrosion protection materials.

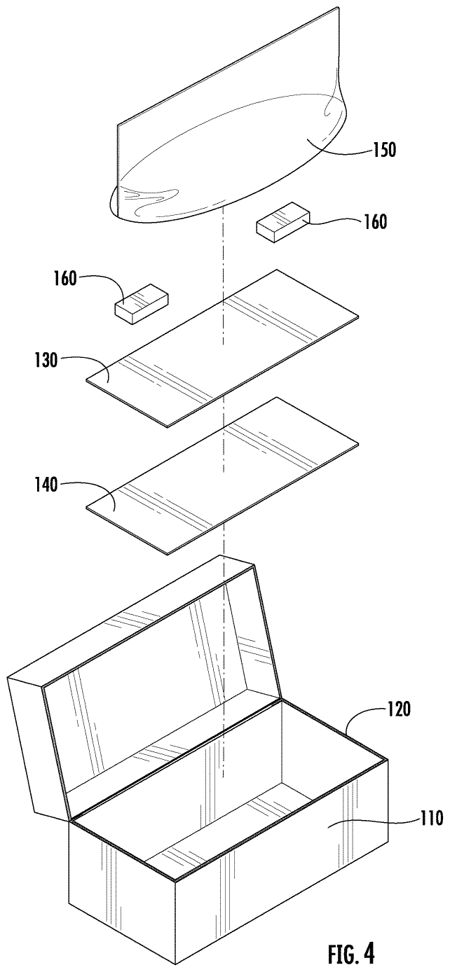

Referring to FIG. 4, an exploded view of the anti-corrosion packaging system 100 is shown illustrating the arrangement and relationship of the various components. The exploded view depicts the outer shell 110 positioned at a bottom of the assembly, with the outer shell 110 shown in an open configuration with a hinged lid portion. The hermetic zipper 120 is visible along the upper portion of the outer shell 110, enabling selective access to the interior volume. The outer shell 110 includes heat-sealed seams to provide liquid and gas resistance at seam joints of the outer shell 110.

With continued reference to FIG. 4, the rubber matting 140 is shown positioned above the outer shell 110 and is configured to be placed at the bottom of the interior volume to support an industrial item and provide puncture resistance and moisture isolation. The polymeric insert 130 is shown above the rubber matting 140 and is configured to be positioned between an industrial item and the outer shell 110 to protect the outer shell 110 from sharp edges or protrusions on the industrial item.

The anti-corrosion film 150 is depicted at an upper portion of the exploded arrangement of FIG. 4 and comprises a polymeric material configured to be positioned around the industrial item. As further shown in FIG. 4, a plurality of anti-corrosion blocks 160 are positioned within the interior of the anti-corrosion packaging system 100, with two anti-corrosion blocks 160 shown on generally opposite sides of the assembly for illustrative purposes. The anti-corrosion blocks 160 are configured to emit corrosion-inhibiting vapors into the environment surrounding the industrial item. In some embodiments, the anti-corrosion packaging system 100 may include four anti-corrosion blocks 160 per package, such as commercially available vapor corrosion inhibitor blocks (e.g., VC2-2 blocks marketed under the ZeRust® brand), although other vapor-emitting corrosion inhibitor blocks or sources may be used.

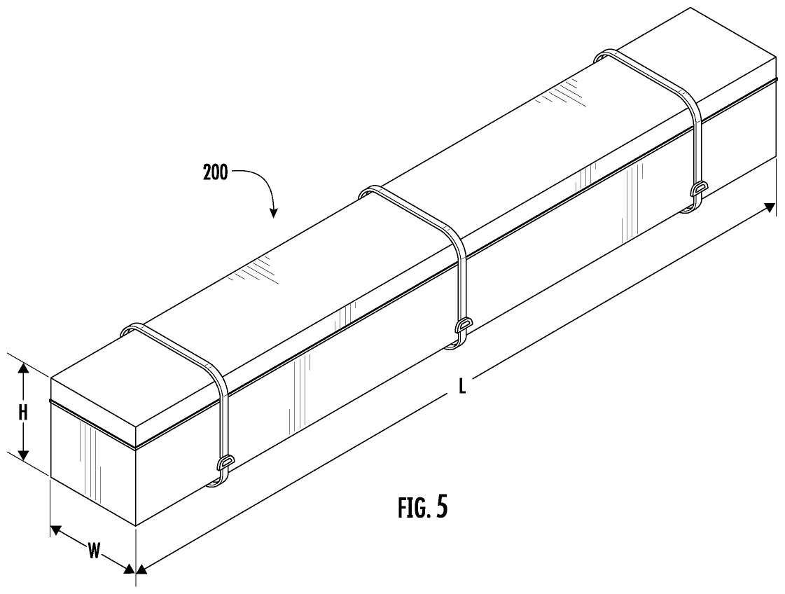

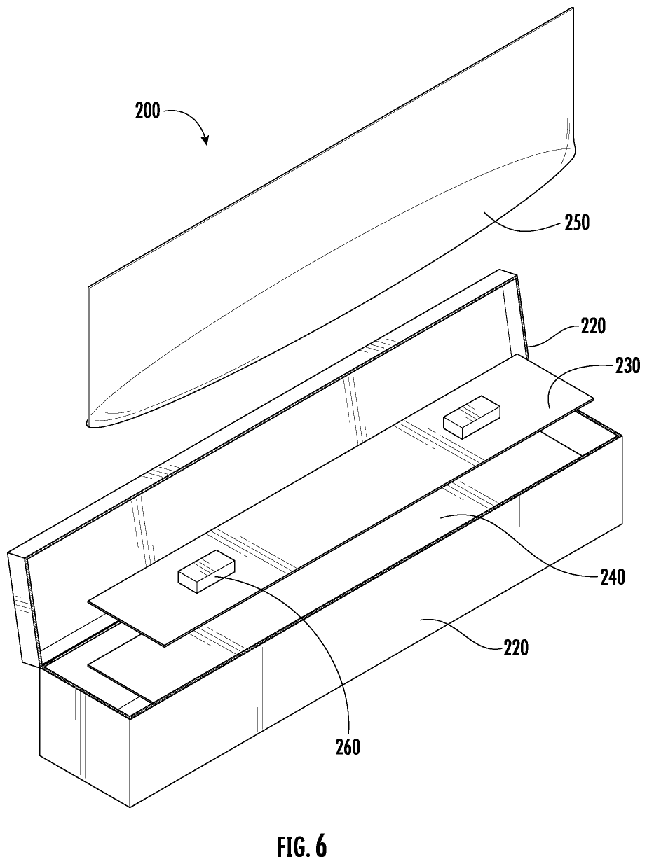

Referring to FIGS. 5 and 6, an anti-corrosion packaging system 200 according to a second embodiment is illustrated. The anti-corrosion packaging system 200 is substantially identical in construction and operation to the anti-corrosion packaging system 100 described above with respect to FIGS. 1-4, except that the system 200 is configured in a larger form factor to accommodate industrial items having increased length, width, or overall volume. As shown, the packaging system 200 includes a soft-sided outer container defining an interior volume having dimensions indicated by a length L, a width W, and a height H. The packaging system 200 may further include a liquid- and gas-tight zipper 220 extending along an upper portion of the outer container, cinch straps with D-rings positioned at spaced intervals along the length of the container to secure the package during transport, and internal components arranged in the same layered relationship as described above, including a floor mat, protective insert, anti-corrosion film, and one or more anti-corrosion inhibitor sources. In this embodiment, the anti-corrosion film is not hermetically sealed and may have an open end positioned beneath the floor mat. The exploded view of FIG. 6 illustrates the relative arrangement of these components for assembly.

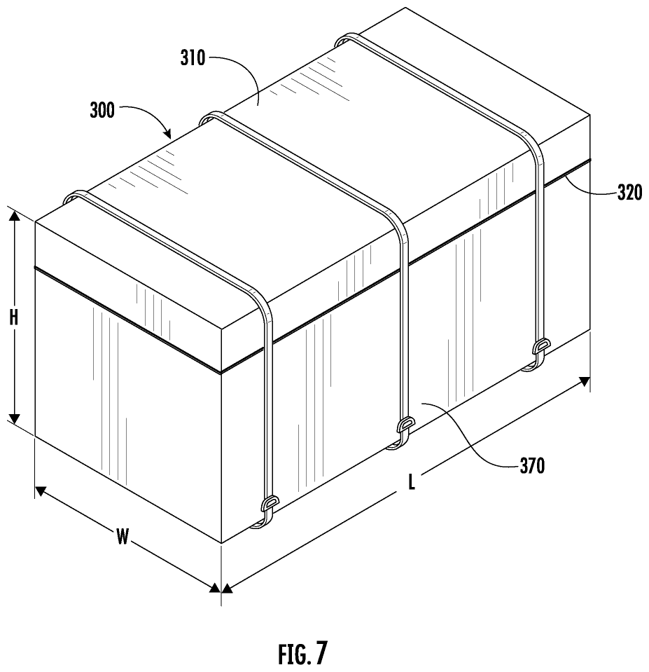

Referring to FIGS. 7-9 , an anti-corrosion packaging system 300 according to a third embodiment is illustrated. The anti-corrosion packaging system 300 is generally similar in construction and operation to the anti-corrosion packaging systems 100 and 200 described above with respect to FIGS. 1-6, and includes a soft-sided outer shell 310 defining an interior volume sized to receive an industrial item, a closure mechanism 320, one or more cinch straps 370 with D-rings, and internal packaging components arranged in a layered relationship. As illustrated, the outer shell 310 may have a generally rectangular configuration defined by a height H, a width W, and a length L, and may be formed from a polymeric fabric material, such as an 18 oz vinyl fabric.

However, in contrast to the first and second embodiments, the third embodiment is configured such that an anti-corrosion film 350 is positioned around both the industrial item and a rubber matting 340, with an open upper end of the anti-corrosion film 350 extending upward and remaining accessible from above within the interior volume of the outer shell 310. In this configuration, the anti-corrosion film 350 surrounds the industrial item and the rubber matting 340 and may be sealed to form a substantially sealed anti-corrosion envelope around the industrial item.

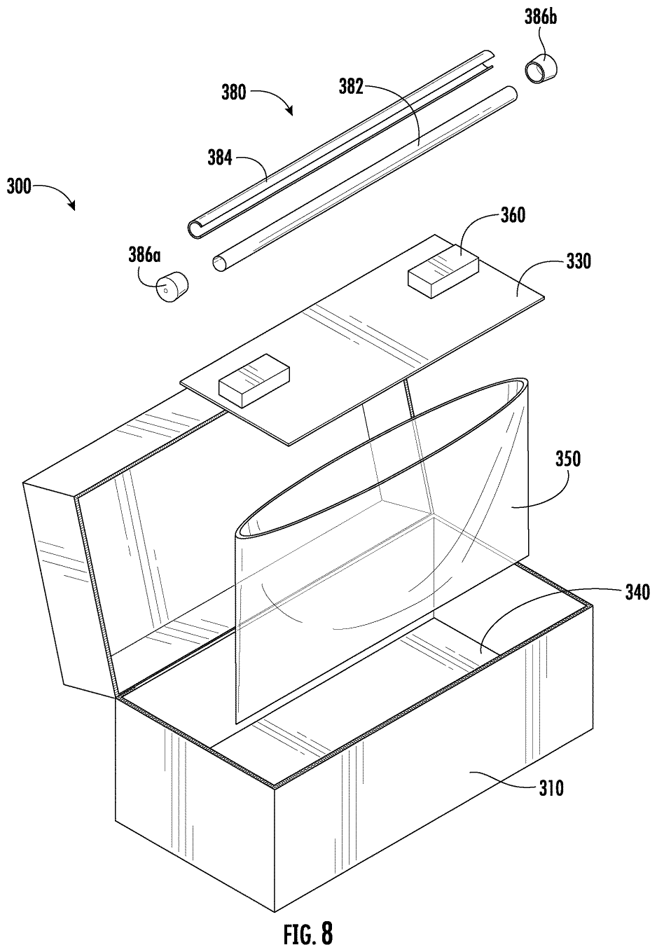

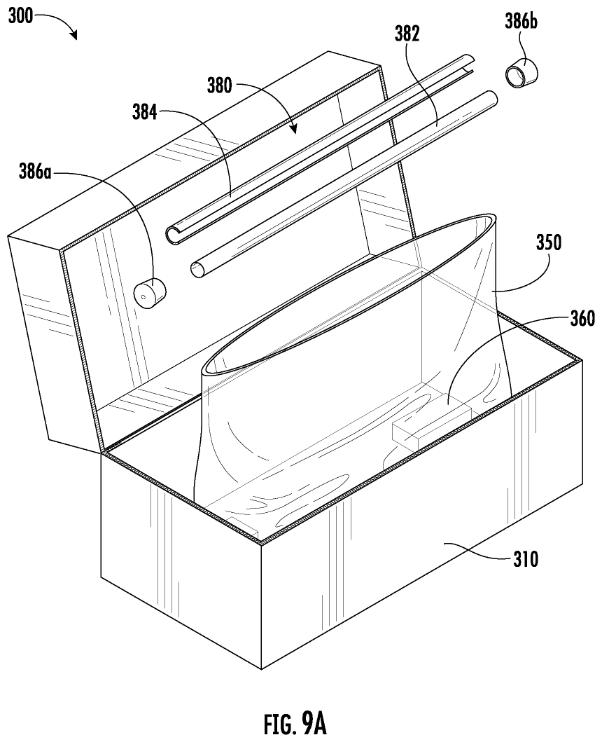

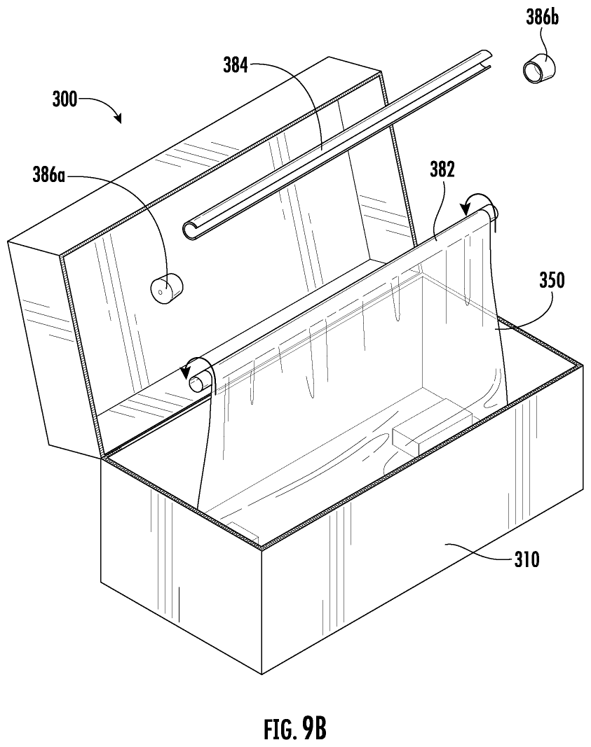

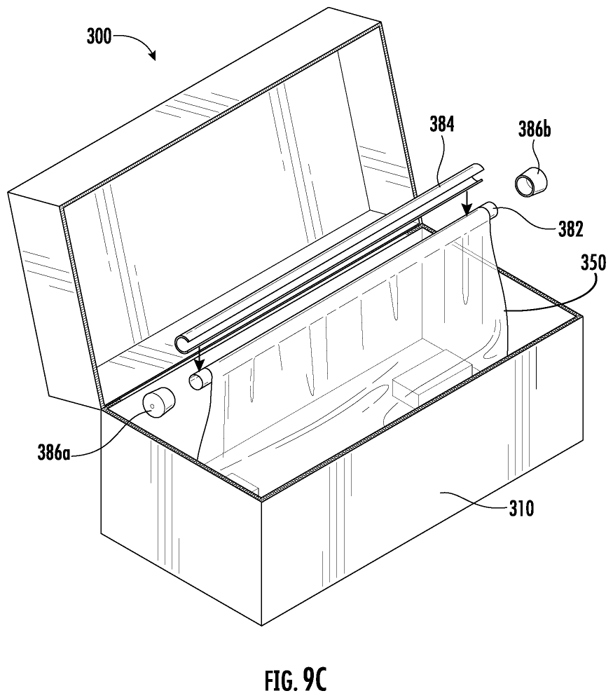

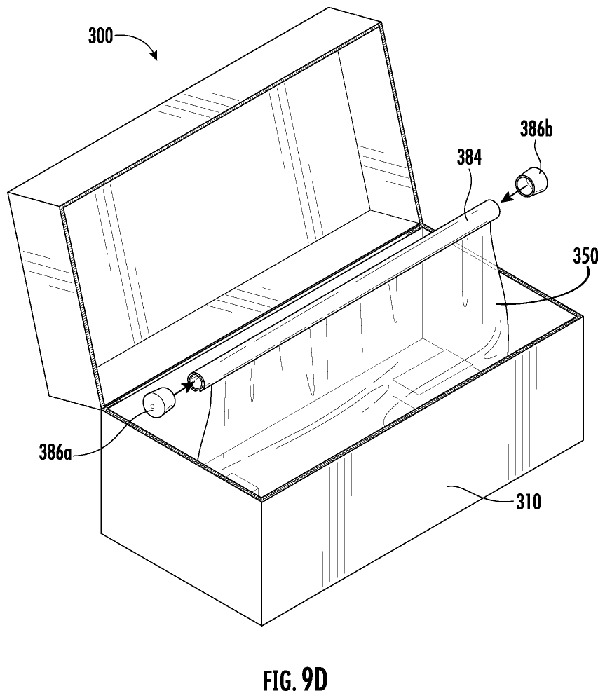

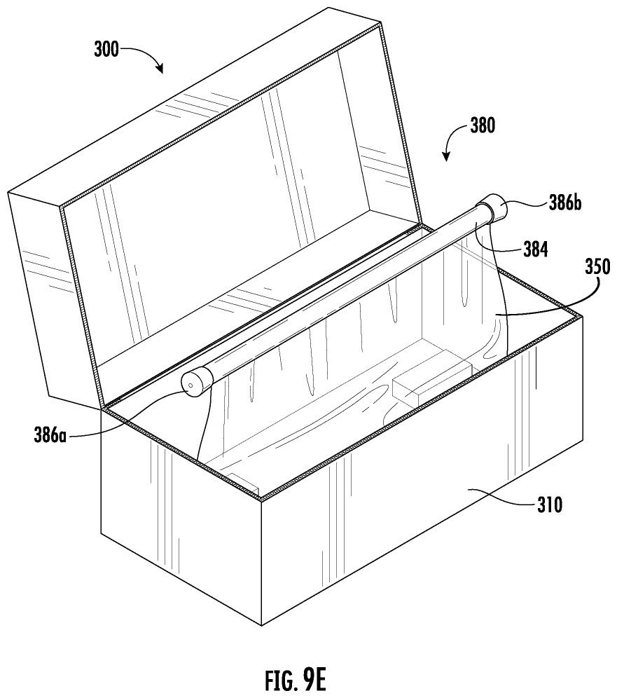

Referring to FIGS. 8 and 9A-9E, the anti-corrosion packaging system 300 includes a tubular compression closure assembly 380 configured to seal the open upper end of the anti-corrosion film 350. The tubular compression closure assembly 380 is sized and configured based on the dimensions of the anti-corrosion film 350 such that the closure assembly seals the film independently of the outer shell geometry. The tubular compression closure assembly 380 comprises an inner rod 382 having a circular cross-section, a slotted resilient sleeve clamp 384 having a circular cross-section and configured to mate with the inner rod 382 to apply a compressive force, and a first end cap 386a and a second end cap 386b configured to secure the sleeve clamp 384 to the inner rod 382. In this configuration, the tubular compression closure assembly 380 provides a substantially sealed environment around the industrial item independent of the outer shell 310, such that the closure mechanism 320 of the outer shell may comprise any suitable closure mechanism for opening and closing the outer shell without being required to provide a gas-tight or liquid-tight seal, although a hermetic zipper closure may optionally be provided to offer additional protection against leakage.

In use, the open upper end of the anti-corrosion film 350 is wrapped around the inner rod 382, after which the slotted resilient sleeve clamp 384 is positioned over the inner rod 382 to compress the anti-corrosion film material between the sleeve clamp 384 and the inner rod 382, thereby sealing the film. The first and second end caps 386a, 386b are then applied to retain the sleeve clamp 384 in position and prevent accidental detachment. FIGS. 9A-9E illustrate successive stages of this sealing operation, from an unassembled state to a fully assembled, sealed configuration. Once the anti-corrosion film is sealed using the tubular compression closure assembly 380, the outer shell 310 may be closed using the closure mechanism 320.

The soft-sided polymeric packaging systems described herein provide corrosion protection for industrial items through the coordinated interaction of multiple components that together establish and maintain a corrosion-inhibiting atmosphere within the packaging interior.

The soft-sided outer container functions as a primary environmental barrier that isolates the interior volume from external conditions. The polymeric fabric construction of the outer container resists moisture penetration and provides a degree of thermal insulation that may reduce temperature fluctuations within the interior volume. The liquid-tight and gas-tight zipper closure enables the outer container to be selectively opened for loading and unloading of industrial items while providing a sealed enclosure when closed. Heat-sealed seams along the outer container may further reduce pathways for moisture or gas exchange between the interior volume and the external environment.

The floor mat positioned at the bottom of the interior volume serves multiple functions within the packaging system. The floor mat supports the weight of the industrial item and distributes loading forces across the bottom surface of the outer container. The floor mat may provide puncture resistance that protects the outer container from damage caused by concentrated loads or sharp features on the underside of the industrial item. The floor mat may also provide moisture isolation between the industrial item and the bottom surface of the outer container, reducing the potential for moisture accumulation at the interface between the industrial item and the packaging.

The protective insert functions to shield the outer container and other internal packaging components from damage caused by sharp edges, protrusions, or irregular surfaces on the industrial item. By positioning the protective insert between the industrial item and the outer container, the protective insert may absorb or distribute contact forces that might otherwise puncture or tear the outer container or the anti-corrosion film. The protective insert may be wrapped around portions of the industrial item having sharp edges or positioned along interior surfaces of the outer container where contact with the industrial item is anticipated.

The anti-corrosion film provides a localized corrosion-inhibiting environment in proximity to the industrial item. The anti-corrosion film may incorporate vapor corrosion inhibitors that emit corrosion-inhibiting vapors into the enclosed space surrounding the industrial item. The corrosion-inhibiting vapors may form a protective molecular layer on metal surfaces of the industrial item, reducing the rate of oxidation and corrosion reactions. The anti-corrosion film may be positioned over and around the industrial item to create an envelope that concentrates the corrosion-inhibiting vapors in the immediate vicinity of the surfaces requiring protection.

The anti-corrosion inhibitor sources supplement the corrosion protection provided by the anti-corrosion film. The anti-corrosion inhibitor sources may emit vapor corrosion inhibitors that diffuse throughout the interior volume of the packaging system, maintaining a corrosion-inhibiting atmosphere even in regions not directly covered by the anti-corrosion film. The quantity and placement of the anti-corrosion inhibitor sources may be selected based on the internal volume of the packaging system and the surface area of the industrial item requiring protection. The anti-corrosion inhibitor sources may continue to emit corrosion-inhibiting vapors over extended storage periods, replenishing the protective atmosphere as vapors are absorbed by metal surfaces or lost through minor leakage pathways.

In configurations where the anti-corrosion film is not hermetically sealed, the continuous emission of corrosion-inhibiting vapors from the anti-corrosion film and the anti-corrosion inhibitor sources may maintain a protective environment around the industrial item. The open end of the anti-corrosion film may be positioned beneath the floor mat, which may reduce the rate of vapor loss from the anti-corrosion film envelope while allowing the anti-corrosion film to be positioned without specialized sealing equipment.

In configurations where the anti-corrosion film is sealed using a tubular compression closure assembly, the anti-corrosion film may form a substantially sealed envelope around the industrial item. The sealed configuration may provide enhanced environmental isolation suitable for applications requiring long-term storage, transport in high-humidity environments, or protection of corrosion-sensitive components.

The soft-sided, modular construction of the packaging systems described herein may provide advantages in handling flexibility compared to rigid metal shipping containers. The soft-sided outer container may conform to irregularly shaped industrial items and may be manipulated during loading and unloading operations without requiring specialized lifting equipment. The soft-sided construction may reduce the overall weight of the packaging system compared to rigid metal containers of similar internal volume.

The soft-sided packaging systems may exhibit a reduced storage footprint when empty compared to rigid metal shipping containers. The soft-sided outer container may be collapsed or folded when not in use, reducing the volume occupied by empty packaging during storage or return shipment. The collapsible nature of the soft-sided outer container may reduce transportation costs associated with repositioning empty packaging across multiple sites.

The modular nature of the packaging systems may allow the components to be scaled and adapted to accommodate industrial items of varying sizes and geometries. The outer container, floor mat, protective insert, anti-corrosion film, and anti-corrosion inhibitor sources may be selected and configured based on the dimensions and corrosion protection requirements of the specific industrial item being packaged. The modular approach may allow a range of industrial shipping and storage applications to be addressed using common component types configured in application-specific arrangements.

Many modifications and other embodiments of the inventions set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An anti-corrosion packaging system, comprising:
a soft-sided outer container formed from a polymeric fabric and defining an interior volume sized to receive an industrial item, the outer container including a closure mechanism positioned along an upper portion of the outer container;
a floor mat positioned at a bottom of the interior volume, the floor mat configured to support the industrial item and provide puncture resistance and moisture isolation;
an anti-corrosion film configured to be positioned around the industrial item, the anti-corrosion film comprising a polymeric material incorporating vapor corrosion inhibitors configured to emit corrosion-inhibiting vapors into an enclosed environment surrounding the industrial item;
one or more anti-corrosion inhibitor sources disposed within the interior volume; and
a tubular compression closure assembly configured to seal the open upper end of the anti-corrosion film, the tubular compression closure assembly comprising: (i) an inner rod having a circular cross-section; (ii) a slotted resilient sleeve clamp having a circular cross-section and adapted to mate to the inner rod and apply a compressive force; and (iii) first and second end caps configured to secure the sleeve clamp to the inner rod.

2. The anti-corrosion packaging system of claim 1, wherein the slotted resilient sleeve clamp is constructed of a resilient material comprising an elastomeric plastic.

3. The anti-corrosion packaging system of claim 2, wherein a longitudinal slot is formed in the slotted resilient sleeve clamp to facilitate the slotted resilient sleeve clamp being slid over the inner rod.

4. The anti-corrosion packaging system of claim 1, further comprising a protective insert comprising a non-woven polypropylene sheet configured to be positioned between the industrial item and the outer container.

5. The anti-corrosion packaging system of claim 1, wherein the closure mechanism comprises a hermetic zipper extending along the upper portion of the outer container.

6. The anti-corrosion packaging system of claim 1, wherein the outer container comprises heat-sealed seams.

7. The anti-corrosion packaging system of claim 1, wherein the polymeric fabric comprises vinyl.

8. The anti-corrosion packaging system of claim 7, wherein the polymeric fabric comprises 18 oz vinyl.

9. The anti-corrosion packaging system of claim 1, wherein the floor mat comprises a rubber mat or an elastomeric mat.

10. The anti-corrosion packaging system of claim 1, wherein the one or more anti-corrosion inhibitor sources comprise vapor corrosion inhibitor emitters, vapor corrosion inhibitor capsules, or vapor corrosion inhibitor blocks.

11. The anti-corrosion packaging system of claim 1, further comprising one or more cinch straps with D-rings positioned on an exterior of the outer container.

12. A method of packaging an industrial item for corrosion-protected shipping or storage, comprising:
positioning a floor mat at a bottom of an interior volume of a soft-sided outer container formed from a polymeric fabric;
placing the industrial item on the floor mat within the interior volume;
positioning an anti-corrosion film around the industrial item, the anti-corrosion film comprising a polymeric material incorporating vapor corrosion inhibitors configured to emit corrosion-inhibiting vapors;
disposing one or more anti-corrosion inhibitor sources within the interior volume; and
closing a zipper closure positioned along an upper portion of the outer container.

13. The method of claim 12, wherein positioning the anti-corrosion film comprises positioning the anti-corrosion film over the industrial item and tucking an open end of the anti-corrosion film beneath the floor mat.

14. The method of claim 13, further comprising wrapping sharp edges of the industrial item with a protective insert comprising a non-woven polypropylene sheet prior to positioning the anti-corrosion film.

15. The method of claim 12, wherein positioning the anti-corrosion film comprises positioning the anti-corrosion film around both the industrial item and the floor mat such that an open upper end of the anti-corrosion film extends upward, the method further comprising sealing the open upper end of the anti-corrosion film using a tubular compression closure assembly.

16. The method of claim 15, further comprising wrapping sharp edges of the industrial item with a protective insert comprising a non-woven polypropylene sheet prior to positioning the anti-corrosion film.
